(19) United States
(12) Patent Application Publication
(10) Pub. No.: US 2025/0158529 A1
(43) Pub. Date: May 15, 2025

(54) POWER CONVERTER AND NON-TRANSITORY COMPUTER READABLE MEDIUM

(71) Applicant: DENSO CORPORATION, Kariya-city (JP)

(72) Inventors: Kazuma SUZUKI, Nisshin-city (JP); Yuichi HANDA, Kariya-city (JP); Yuuki TSUTSU, Kariya-city (JP)

(21) Appl. No.: 19/020,102

(22) Filed: Jan. 14, 2025

Related U.S. Application Data
(63) Continuation of application No. PCT/JP2023/023099, filed on Jun. 22, 2023.

(30) Foreign Application Priority Data
Jul. 18, 2022 (JP) 2022-114433

(51) Int. Cl. H02M 3/335

(52) U.S. Cl. CPC H02M 3/33573; H02M 3/33576

(57) ABSTRACT

A power converter includes external connection terminals, bridge circuits, an inductance element and a controller. The bridge circuits are connected to the external connection terminals, respectively. The inductance element is connected between an AC terminal of one of two of the bridge circuits and an AC terminal of another one of two of the bridge circuits. The two of the bridge circuits are capable of transmitting power. A closed-loop circuit is formed by the two of the bridge circuits and the inductance element. The closed-loop circuit includes a capacitor connected between the inductance element and at least one of AC terminals of the two of the bridge circuit. The controller drives switching elements at a switching frequency being higher than a resonant frequency of the closed-loop circuit.

### CROSS REFERENCE TO RELATED APPLICATIONS

The present application is a continuation application of International Patent Application No. PCT/JP2023/023099 filed on Jun. 22, 2023, which designated the U.S. and claims the benefit of priority from Japanese Patent Application No. 2022-114433 filed on Jul. 18, 2022. The entire disclosures of all of the above applications are incorporated herein by reference.

### TECHNICAL FIELD

The present disclosure relates to a power converter and a non-transitory computer readable medium.

### BACKGROUND

In a power converter, an inductance element such as a transformer may be connected between an AC terminal of one of two bridge circuits and an AC terminal of another one of the two bridge circuits.

### SUMMARY

The present disclosure describes a power converter including external connection terminals, bridge circuits, an inductance element and a controller, and further describes a non-transitory computer readable medium that controls the power converter.

### BRIEF DESCRIPTION OF DRAWINGS

FIG. 1 illustrates a power converter according to a first embodiment.

FIG. 2 is a timing chart that illustrates a switching operation, and current and voltage waveforms.

FIG. 3 illustrates the flow of a current in each operation mode.

FIG. 4 illustrates the relationship between a switching frequency and an impedance of an LC circuit.

FIG. 5 illustrates the relationship between the switching frequency and the amount of reduction in switching losses.

FIG. 6 illustrates port current waveforms.

FIG. 7 illustrates the losses in a semiconductor.

FIG. 8 illustrates a power converter according to a second embodiment.

FIG. 9 illustrates a power converter according to a third embodiment.

FIG. 10 illustrates a power converter according to a fourth embodiment.

FIG. 11 is a timing chart that illustrates a switching operation, and current and voltage waveforms in a power converter according to a fifth embodiment.

FIG. 12 illustrates a power converter according to a sixth embodiment.

FIG. 13 illustrates a power converter according to a modified example.

FIG. 14 illustrates a power converter according to another modified example.

FIG. 15 illustrates a power converter according to a seventh embodiment.

FIG. 16 illustrates the effect of transformer polarization suppression.

FIG. 17 illustrates a power converter according to a modified example.

FIG. 18 illustrates a power converter according to another modified example.

FIG. 19 illustrates a power converter according to an eighth embodiment.

### DETAILED DESCRIPTION

Power converters installed in movable objects such as electric vehicles may be required to be compact from the standpoint of installability. In terms of the size of power converters, passive components such as capacitors and inductors may occupy a significant proportion, making the miniaturization of these passive components effective.

A snubber capacitor may be connected in parallel with the switching elements that form the bridge circuit, utilizing the charging operation of the snubber capacitor to reduce switching losses. By employing such soft switching technology, it is possible to achieve higher frequencies due to the reduction in losses, thereby reducing the size of passive components. However, in light load conditions, the charge stored in the snubber capacitor may become a loss, resulting in lower conversion efficiency compared to configurations without a snubber capacitor. From the viewpoint described above or from other unmentioned viewpoints, there may be a demand for further improvement to a power converter and a control program for controlling the power converter.

According to a first aspect of the present disclosure, a power converter includes external connection terminals, bridge circuits, an inductance element, and a controller. The bridge circuits are connected to the external connection terminals, respectively. The inductance element is provided for each combination of two bridge circuits among all the bridge circuits, and the inductance element is connected between an AC terminal of one of the two bridge circuits and an AC terminal of another one of the two bridge circuits capable of transferring power. The controller drives switching elements included in the bridge circuits. The two of the bridge circuits and the inductance element form a closed-loop circuit. The closed-loop circuit has a capacitor connected between the inductance element and at least one of respective AC terminals of the two bridge circuits. The controller drives the switching elements at a switching frequency higher than a resonant frequency of the closed-loop circuit.

According to the above-mentioned power converter, a capacitor is provided in the closed-loop circuit. For this reason, the power converter drives the switching elements at a higher frequency region than the resonant frequency of the closed-loop circuit, in other words, the inductive region. Therefore, the current waveform is closer to a sine wave so that it is possible to reduce the current value at the switching time. As a result, the power converter has a higher conversion efficiency over a wide range.

According to a second aspect of the present disclosure, a non-transitory computer readable medium is adapted to a power converter having external connection terminals, bridge circuits, an inductance element, and a capacitor. The bridge circuits are connected to the external connection terminals, respectively. The inductance element is provided for each combination of two bridge circuits among all the bridge circuits, and the inductance element is connected between an AC terminal of one of the two bridge circuits and an AC terminal of another one of the two bridge circuits capable of transferring power. The two of the bridge circuits and the inductance element form a closed-loop circuit, and the closed-loop circuit has a capacitor connected between the inductance element and at least one of respective AC terminals of the two bridge circuits. The non-transitory computer readable medium stores a computer program product having instructions that cause a processor to set a switching frequency higher than a resonant frequency of the closed-loop circuit, and drive switching elements included in the bridge circuits at the switching frequency.

According to the above-mentioned non-transitory computer readable medium, it is possible to drive the switching elements at a higher frequency region than the resonant frequency of the closed-loop circuit, in other words, the inductive region. Therefore, the current waveform is closer to a sine wave so that it is possible to reduce the current value at the switching time. As a result, the power converter has a higher conversion efficiency over a wide range.

Hereinafter, several embodiments will be described with reference to drawings. The same or corresponding elements are designated with the same reference numerals throughout the embodiments, and descriptions thereof will not be repeated. When only part of the configuration is described in each embodiment, the configuration of the other preceding embodiments can be applied to other parts of the configuration. Further, not only the combinations of the configurations explicitly shown in the description of the respective embodiments, but also the configurations of the plurality of embodiments can be partially combined even if they are not explicitly shown if there is no problem in the combinations in particular.

A power converter according to one or more embodiments may be adapted to a movable object. The movable object is, e.g., an electrically driven vehicle such as an electric vehicle (BEV), a hybrid vehicle (HEV), or a plug-in hybrid vehicle (PHEV), a flying object, a ship, a construction machine, or an agricultural machine. The flying object may be, for example, an electric vertical takeoff and landing aircraft or a drone. The power converter can also be applied to stationary equipment where miniaturization is required.

### First Embodiment

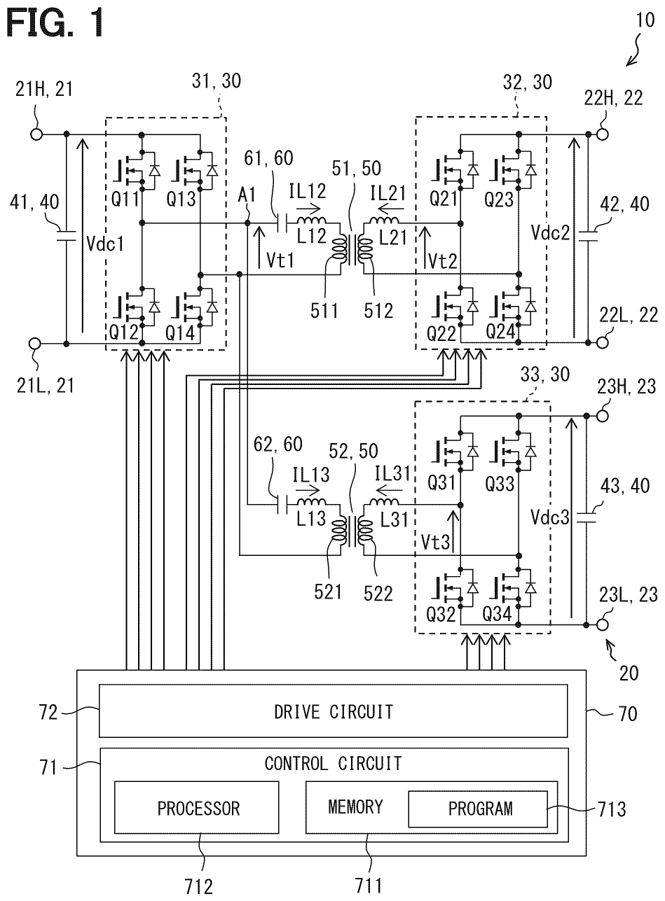

FIG. 1 shows the overall configuration of a power converter 10 according to the present embodiment. As shown in FIG. 1, the power converter 10 includes multiple external connection terminals 20, multiple bridge circuits 30, an inductance element 50, a capacitor 60, and a controller 70. The power converter 10 further includes a smoothing capacitor 40. The power converter 10 is a device for converting DC power to DC power. The power converter 10 is sometimes referred to as a DC-DC converter.

The external connection terminal 20 is a terminal for electrically connecting the power converter 10 to an external device. The external connection terminal 20 inputs or outputs power. Therefore, the external connection terminal 20 may be referred to as the input/output terminal. An external device is, for example, a rechargeable secondary battery, an AC-DC conversion circuit, or a load. All external devices connected to the external connection terminals 20 may be secondary batteries or AC-DC conversion circuits. Some of the external devices connected to the external connection terminals 20 may be secondary batteries or AC-DC conversion circuits, while other external devices may be loads.

As an example, the power converter 10 according to the present embodiment includes three external connection terminals 20, specifically the first terminal 21, the second terminal 22, and the third terminal 23. Among the first terminals 21, the first terminal 21H is the high potential terminal, and the first terminal 21L is the low potential terminal. Similarly, among the second terminals 22, the second terminal 22H is the high potential terminal, and the second terminal 22L is the low potential terminal. Among the third terminals 23, the third terminal 23H is the high potential terminal, and the third terminal 23L is the low potential terminal. The voltage of the first terminal 21, that is, the potential difference between the first terminal 21H and 21L, is a high voltage of, for example, 300 volts or more. The same applies to the voltage of the second terminal 22 and the voltage of the third terminal 23.

The bridge circuits 30 are connected to the external connection terminals 20, respectively. The bridge circuit 30 is connected in parallel to the external connection terminals 20. The bridge circuit 30 has a high potential DC terminal, a low potential DC terminal, and an AC terminal. The high potential side DC terminal is connected to the high potential side of the external connection terminal 20, and the low potential side DC terminal is connected to the low potential side of the external connection terminal 20. The AC terminal is connected to the inductance element 50. The bridge circuit 30 converts DC power to AC power or converts AC power to DC power. The bridge circuit 30 may be referred to as, for example, a power conversion circuit, an AC-DC conversion circuit, and an inverter.

The bridge circuit 30 includes at least one series circuit of switching elements. The series circuit is sometimes referred to as a bridge, switching leg, or upper and lower arm circuit. The switching elements that make up the series circuit are, for example, metal oxide semiconductor field effect transistors (MOSFETs) or insulated gate bipolar transistors (IGBTs).

As an example, the power converter 10 according to the present embodiment includes three bridge circuits 30, specifically the first bridge circuit 31, the second bridge circuit 32, and the third bridge circuit 33. The power converter 10 includes the same number of bridge circuits 30 as external connection terminals 20. Each bridge circuit 30 is a full-bridge circuit equipped with two series circuits. The switching elements that make up the series circuit are all n-channel type MOSFETs. The diodes shown in the drawing are parasitic diodes of the MOSFETs, and they allow for freewheeling.

The first bridge circuit 31 has four switching elements Q11, Q12, Q13, and Q14. The two switching elements Q11 and Q12 form a series circuit with the switching element Q11 on the high-side. The source of the switching element Q11 and the drain of the switching element Q12 are connected to each other. The two switching elements Q13 and Q14 form a series circuit with the switching element Q13 on the high-side. The source of the switching element Q13 and the drain of the switching element Q14 are connected to each other.

The drains of the high-side switching elements Q11 and Q13 are connected to the high-potential DC terminal of the first bridge circuit 31. The sources of the low-side switching elements Q12 and Q14 are connected to the low-potential DC terminal of the first bridge circuit 31. The midpoint (connection point) of the series circuit is connected to the AC terminal of the first bridge circuit 31.

The second bridge circuit 32 has the same configuration as the first bridge circuit 31. The second bridge circuit 32 includes four switching elements Q21, Q22, Q23, and Q24. The two switching elements Q21 and Q22 form a series circuit, with the switching element Q21 positioned on the high-side. The two switching elements Q23 and Q24 form a series circuit, with the switching element Q23 positioned on the high-side. The drains of the high-side switching elements Q21 and Q23 are connected to the high potential side DC terminal of the second bridge circuit 32. The sources of the low-side switching elements Q22 and Q24 are connected to the low potential side DC terminal of the second bridge circuit 32. The midpoint (connection point) of the series circuit is connected to the AC terminal of the second bridge circuit 32.

The third bridge circuit 33 has a configuration similar to that of the first bridge circuit 31. The third bridge circuit 33 has four switching elements Q31, Q32, Q33, Q34. The two switching elements Q31 and Q32 form a series circuit, with the switching element Q31 positioned on the high-side. The two switching elements Q33 and Q34 form a series circuit, with the switching element Q33 positioned on the high-side. The drains of the high-side switching elements Q31 and Q33 are connected to the high-potential side DC terminal of the third bridge circuit 33. The sources of the low-side switching elements Q32 and Q34 are connected to the low-potential side DC terminal of the third bridge circuit 33. The midpoint (connection point) of the series circuit is connected to the AC terminal of the third bridge circuit 33.

The smoothing capacitor 40 is provided between the external connection terminal 20 and the bridge circuit 30. The smoothing capacitor 40 is connected in parallel to the external connection terminal 20. The smoothing capacitor 40 is connected in parallel with the bridge circuit 30. As the smoothing capacitor 40, for example, a film capacitor or an electrolytic capacitor can be used. The power converter 10 is equipped with the same number of smoothing capacitors 40 as the bridge circuits 30.

As an example, the power converter 10 according to the present embodiment includes three smoothing capacitors 40, specifically the first smoothing capacitor 41, the second smoothing capacitor 42, and the third smoothing capacitor 43. The positive terminal of the first smoothing capacitor 41 is connected to the high potential side first terminal 21H, and the negative terminal is connected to the low potential side first terminal 21L. The positive terminal of the second smoothing capacitor 42 is connected to the high potential side second terminal 22H, and the negative terminal is connected to the low potential side second terminal 22L. The positive terminal of the third smoothing capacitor 43 is connected to the high potential side third terminal 23H, and the negative terminal is connected to the low potential side third terminal 23L. The positive terminal of the smoothing capacitor 40 is connected to the high potential side DC terminal of the bridge circuit 30, and the negative terminal is connected to the low potential side DC terminal.

The smoothing capacitor 40, together with the bridge circuit 30, may be referred to as a power conversion circuit. The first bridge circuit 31 performs power conversion between the AC terminal of the first bridge circuit 31 and the first smoothing capacitor 41. The DC voltage Vdc1 is the voltage between both ends of the first smoothing capacitor 41. The first bridge circuit 31 converts, for example, the DC voltage Vdc1 to the AC voltage. The second bridge circuit 32 performs power conversion between the AC terminal of the second bridge circuit 32 and the second smoothing capacitor 42. The DC voltage Vdc2 is the voltage between both ends of the second smoothing capacitor 42. The third bridge circuit 33 performs power conversion between the AC terminal of the third bridge circuit 33 and the third smoothing capacitor 43. The DC voltage Vdc3 is the voltage between both ends of the third smoothing capacitor 43.

The inductance element 50 is connected between the AC terminals of any two bridge circuits 30 that can transmit power. The power converter 10 is capable of freely performing power conversion for transmitting and receiving power between the two bridge circuits 30 with the inductance element 50 in between. It is also possible to freely control the direction of the power. In the circuit with the inductance element 50 in between, the power transmitting side is sometimes referred to as the primary side, and the power receiving side as the secondary side.

As an example, the inductance element 50 in this embodiment is a transformer. The transformer electrically isolates the two bridge circuits 30. The power converter 10 includes two inductance elements 50, specifically the first transformer 51 and the second transformer 52.

The first transformer 51 is connected between the AC terminals of the first bridge circuit 31 and the AC terminals of the second bridge circuit 32. The first transformer 51 has a first coil 511 and a second coil 512. The first coil 511 and the second coil 512 are magnetically coupled to each other through a core (not shown) provided in the first transformer 51, for example. The first coil 511 is connected to the AC terminals of the first bridge circuit 31. One end of the first coil 511 is connected to the AC terminal of the series circuit formed by the switching elements Q11 and Q12, and the other end is connected to the AC terminal of the series circuit formed by the switching elements Q13 and Q14. The second coil 512 is connected to the AC terminals of the second bridge circuit 32. One end of the second coil 512 is connected to the AC terminal of the series circuit formed by the switching elements Q21 and Q22, and the other end is connected to the AC terminal of the series circuit formed by the switching elements Q23 and Q24.

The number of turns of the winding of the first coil 511 is N12, and the number of turns of the winding of the second coil 512 is N21. When the primary side is defined as the first bridge circuit 31 side, a voltage Vt2, corresponding to the product of the voltage Vt1 between the AC terminals of the first bridge circuit 31 and the turn ratio N21/N12, is generated between the AC terminals of the second bridge circuit 32, which is the secondary side. The voltage Vt1 may be referred to as the output voltage of the first bridge circuit 31. The voltage Vt2 may be referred to as the output voltage of the second bridge circuit 32.

The second transformer 52 is connected between the AC terminals of the first bridge circuit 31 and the AC terminals of the third bridge circuit 33. The second transformer 52 has the same configuration as the first transformer 51. The second transformer 52 has a first coil 521 and a second coil 522. The first coil 521 and the second coil 522 are magnetically coupled to each other through a core (not shown) provided in the second transformer 52, for example. The first coil 521 is connected to the AC terminals of the first bridge circuit 31. One end of the first coil 521 is connected to the AC terminal of the series circuit formed by the switching elements Q11 and Q12, and the other end is connected to the AC terminal of the series circuit formed by the switching elements Q13 and Q14. The second coil 522 is connected to the AC terminals of the third bridge circuit 33. One end of the second coil 522 is connected to the AC terminal of the series circuit formed by the switching elements Q31 and Q32, and the other end is connected to the AC terminal of the series circuit formed by the switching elements Q33 and Q34.

The number of turns of the winding of the first coil 521 is N13, and the number of turns of the winding of the second coil 522 is N31. When the first bridge circuit 31 side is considered the primary side, a voltage Vt3 corresponding to the product of the voltage Vt1 between the AC terminals of the first bridge circuit 31 and the turn ratio N31/N13 is generated between the AC terminals of the third bridge circuit 33, which is the secondary side. The voltage Vt3 may be referred to as the output voltage of the third bridge circuit 33.

The inductances L12 and L21 shown in FIG. 1 are the leakage inductances of the first transformer 51. The inductances L12, L21 are equivalent. The inductances L13, L31 are the leakage inductances of the second transformer 52. The inductances L13, L31 are equivalent. The inductances L12, L13, L21, L31 are equal to each other. Inductance is not limited to leakage inductance alone. Additional inductors may be connected to the first transformer 51 and the second transformer 52.

The current IL12 is the current flowing through the inductance L12, which is the first coil 511. The current IL21 is the current flowing through the inductance L21, which is the second coil 512. The current IL13 is the current flowing through the inductance L13, which is the first coil 521. The current IL31 is the current flowing through the inductance L31, which is the second coil 522. These currents IL12, IL21, IL13, and IL31 may be referred to as, for example, transformer currents or port currents.

The capacitor 60 is arranged in a closed-loop circuit that includes any two bridge circuits 30 and an inductance element 50 connected between the AC terminals of any two bridge circuits 30. The capacitor 60 is connected in a closed-loop circuit between at least one of the AC terminals of the two bridge circuits 30 and the inductance element 50. The closed-loop circuit has a capacitor 60. The capacitor 60 is a capacitor for resonant.

As an example, the power converter 10 according to this embodiment includes two capacitors 60, specifically the first capacitor 61 and the second capacitor 62. The first capacitor 61 is arranged in a closed-loop circuit that includes the first bridge circuit 31, the first transformer 51, and the second bridge circuit 32. This closed-loop circuit may be referred to as the first closed-loop circuit hereafter. The first capacitor 61 is connected between the AC terminals on the side of the switching elements Q11 and Q12 in the first bridge circuit 31 and the first coil 511. The first capacitor 61 forms an LC series resonant circuit with the inductances L12, L21, which are the leakage inductances of the first transformer 51.

The second capacitor 62 is arranged in a closed-loop circuit that includes the first bridge circuit 31, the second transformer 52, and the third bridge circuit 33. This closed-loop circuit may be referred to as the second closed-loop circuit hereafter. The second capacitor 62 is connected between the AC terminals on the side of the switching elements Q11 and Q12 in the first bridge circuit 31 and the first coil 521. The second capacitor 62 forms an LC series resonant circuit with the inductances L13 and L31, which are the leakage inductances of the second transformer 52.

As an example, the capacitance value of the first capacitor 61 and the capacitance value of the second capacitor 62 are equal to each other. Therefore, the resonant frequency of the first closed-loop circuit and the resonant frequency of the second closed-loop circuit are equal to each other. The second bridge circuit 32, the first transformer 51, the second transformer 52, and the third bridge circuit 33 form a closed-loop circuit (third closed-loop circuit). Taking the first closed-loop circuit as a reference, the composite inductance in the third closed-loop circuit is doubled, and the composite capacitance is halved. Therefore, the resonant frequency of the third closed-loop circuit is equal to the resonant frequency of the first closed-loop circuit and the second closed-loop circuit.

The controller 70 controls the driving of the switching elements that construct each bridge circuit 30, specifically, the on-drive and off-drive. As a result, the controller 70 converts the AC voltage to the DC voltage after converting the DC voltage to the AC voltage. The controller 70 controls the power transmitted and received between the primary side and the secondary side. The controller 70 according to the present embodiment controls the driving of the switching elements Q11 to Q14, Q21 to Q24, Q31 to Q34. The controller 70 includes a control circuit 71 and a drive circuit 72. The controller 71 generates drive commands to operate the switching elements Q11 to Q14, Q21 to Q24, and Q31 to Q34, and outputs them to the drive circuit 72. The control circuit 71 outputs a pulse width modulation (PWM) signal as the drive command.

As an example, the control circuit 71 according to the present embodiment includes a dedicated computer. The dedicated computer has at least one memory 711 and at least one processor 712. The memory 711 is a non-transitory tangible storage medium that non-temporarily stores computer-readable program 713 and data. The program 713 includes computer-readable instructions that, when executed by the processor 712, cause the processor 712 to perform various functions. The processor 712 constructs multiple function units by executing multiple instructions included in the program 713. The processor 712 is a processing unit that executes predetermined processing by executing the instructions of the program 713.

The memory 711 is at least one type of storage medium, such as, for example, semiconductor memory, magnetic media, and optical media. The memory 711 can employ a variety of storage media such as Random Access Memory (RAM), Read Only Memory (ROM), Hard-disk Drive (HDD), and Solid State Drive (SSD).

The processor 712 includes at least one of the Central Processing Unit (CPU), Micro-Processing Unit (MPU), Graphics Processing Unit (GPU), and Data Flow Processor (DFP) as a core. The control circuit 71 may be realized by combining multiple types of calculation processing devices such as a CPU, an MPU, and a GPU.

The dedicated computer comprising the control circuit 71 may be realized as a System on Chip (SoC). At least a portion of the dedicated computer may be realized using Application Specific Integrated Circuit (ASIC) or Field-Programmable Gate Array (FPGA).

The drive circuit 72 applies a drive voltage to the gate of the switching elements Q11 to Q14, Q21 to Q24, Q31 to Q34 based on a drive command from the control circuit 71. The drive circuit 72 drives the switching elements Q11 to Q14, Q21 to Q24, and Q31 to Q34 by applying a drive voltage, specifically causing them to turn on and off. The drive circuit may be referred to as a driver.

The control unit 70 drives the switching elements that construct the bridge circuit 30 at a switching frequency fsw that is higher than the resonant frequency fr of the closed-loop circuit. When the power converter 10 includes multiple closed-loop circuits, the controller 70 drives the switching elements at a switching frequency fsw that is higher than the highest resonant frequency frmax among the resonant frequencies fr of the multiple closed-loop circuits. In this embodiment, as described above, the power converter 10 includes three closed-loop circuits, and the resonant frequencies fr of the three closed-loop circuits are equal to each other. Therefore, the controller 70 drives the switching elements Q11 to Q14, Q21 to Q24, and Q31 to Q34 at a switching frequency fsw that is higher than the common resonant frequency fr of the three closed-loop circuits.

### Control Method

The following describes an example where the control circuit 71 controls the first bridge circuit 31 and the second bridge circuit 32. The same applies to the control of the first bridge circuit 31 and the third bridge circuit 33, as well as the control of the second bridge circuit 32 and the third bridge circuit 33. The control circuit 71 controls the driving of the switching elements Q11, Q12, Q13, Q14, Q21, Q22, Q23, Q24.

The control circuit 71 acquires the command power and detection signals from various sensors on the side of the second bridge circuit 32. When the command power is positive, the control circuit 71 divides the input command power by the voltage Vdc2 obtained from the voltage sensor and calculates the command current, which is the command value of the current to be supplied to the second terminal 22H. The command current is set to supply power to external equipment connected to the second terminal 22 through constant power control. The control circuit 71 acquires the current flowing through the second terminal 22H from the current sensor and calculates the current deviation by subtracting the acquired current from the aforementioned command current. The control circuit 71 calculates the command phase difference φ as the control input for feedback control to bring the current deviation to zero. Feedback control is, for example, proportional integration (PI) control or proportional integration differential (PID) control. The control circuit 71 generates the driving commands (PWM signals) of the switching elements Q11, Q12, Q13, Q14, Q21, Q22, Q23, Q24 based on the command phase difference.

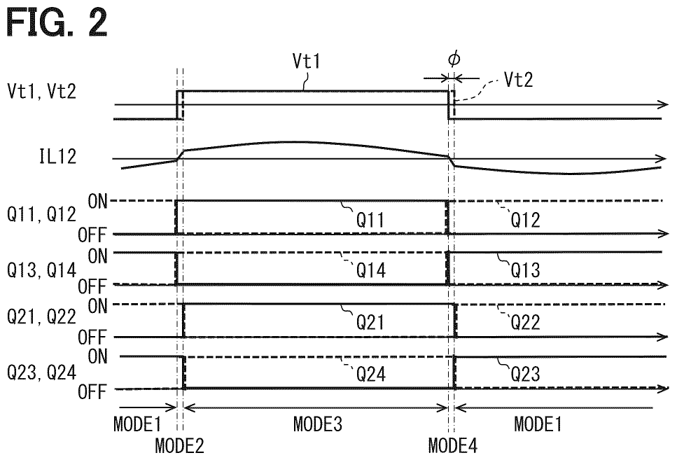

FIG. 2 shows the switching operation, and the current and voltage waveforms. FIG. 2 shows the switching states of the switching elements Q11, Q12, Q13, Q14, Q21, Q22, Q23, and Q24, as well as the voltages Vt1, Vt2, and the current IL1. For convenience, in FIG. 2, the dead time provided to prevent a short circuit in the series circuit is omitted. In FIG. 2, the operation of the switching elements Q11, Q13, Q21, and Q23 is shown with solid lines, while the operation of the switching elements Q12, Q14, Q22, and Q24 is shown with dashed lines.

In the first bridge circuit 31, the switching elements Q11, Q12 forming the series circuit are alternately turned on. The switching elements Q13, Q14 forming the series circuit are alternately turned on. The on-periods of the switching elements Q11 and Q14 are synchronized. The on-periods of the switching elements Q12 and Q13 are synchronized. That is, the switching elements Q11 and Q14 operate in the same switching state, and the switching elements Q12 and Q13 operate in the same switching state.

In the second bridge circuit 32, the switching elements Q21 and Q22, which form a series circuit, are alternately turned on. The switching elements Q23 and Q24, which form a series circuit, are alternately turned on. The on-period of the switching element Q21 is synchronized with the on-period of the switching element Q24. The on-period of the switching element Q22 is synchronized with the on-period of the switching element Q23. In other words, the switching elements Q21 and Q24 operate in the same switching state as each other, and the switching elements Q22 and Q23 operate in the same switching state as each other.

When the command phase difference φ is positive, the timing for switching the switching elements Q21 and Q24 to the on-state is delayed by the command phase difference φ relative to the timing for switching the switching elements Q11 and Q14 to the on-state. During the period of this command phase difference φ, the current IL12 changes and takes on a current waveform as shown in FIG. 2. When the command phase difference φ is positive, the timing for the polarity of the voltage Vt2 to switch from negative to positive is delayed by the command phase difference φ relative to the timing for the polarity of the voltage Vt1 to switch from negative to positive. The control circuit 71 controls the power by controlling the current IL12 based on the command phase difference φ.

In the example shown in FIG. 2, the command phase difference φ (phase difference φ) is positive, and the phase of the voltage Vt2 lags behind the voltage Vt1. Therefore, through the switching operation, power is transmitted from the first bridge circuit 31 to the second bridge circuit 32. Both voltages Vt1 and Vt2 are two-level voltages, taking either positive or negative values. The voltage Vt1 outputs a positive value when the switching elements Q11 and Q14 are turned on, and outputs a negative value when the switching elements Q12 and Q13 are turned on. Similarly, the voltage Vt2 outputs a positive value when the switching elements Q21 and Q24 are turned on, and outputs a negative value when the switching elements Q22 and Q23 are turned on. The control circuit 71 controls the amount of power transmitted from the first bridge circuit 31 to the second bridge circuit 32 by varying the delay amount of the switching timing of the second bridge circuit 32 relative to the switching timing of the first bridge circuit 31.

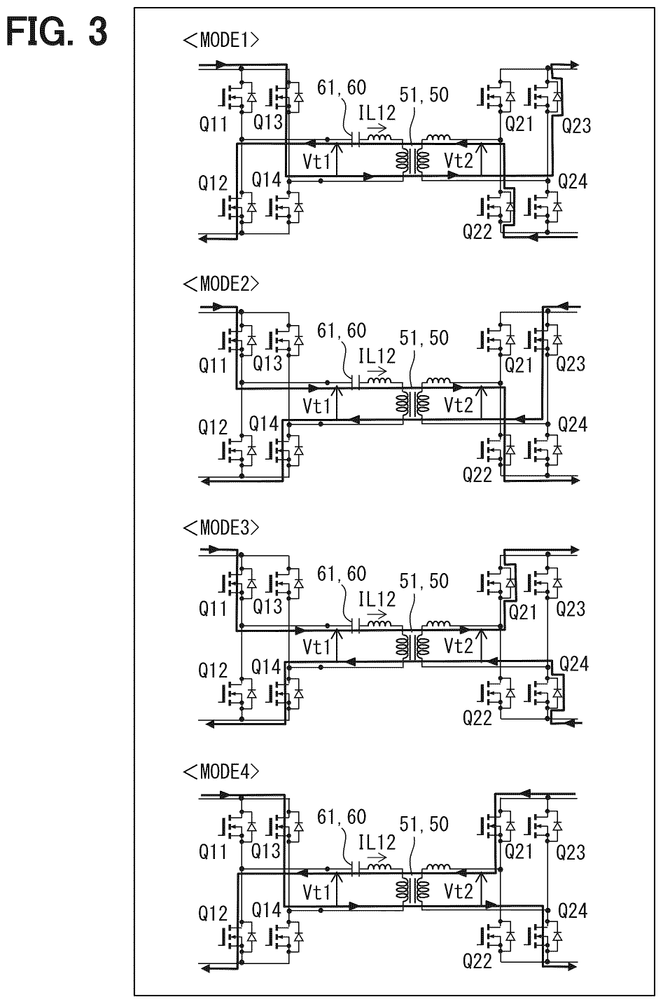

FIG. 3 shows the current flow in each operating mode. In MODE1, the switching elements Q11 and Q14 are kept off, while the switching elements Q12 and Q13 are kept on. The switching elements Q21 and Q24 switch from on to off, while the switching elements Q22 and Q23 switch from off to on. The polarity of the current IL12 is negative, and the current flows through the parasitic diodes of the switching elements Q22 and Q23. The voltage Vt2 falls from a positive value to a negative value. Although current flows through the switching elements Q22 and Q23 in MODE1 due to their being on, this is omitted for convenience in FIG. 3.

Next, in MODE2, the switching elements Q11 and Q14 switch from off to on, while the switching elements Q12 and Q13 switch from on to off. The switching elements Q22 and Q23 remain on, while the switching elements Q21 and Q24 remain off. Since the polarity of the current IL12 is positive, the current flows through the switching elements Q22 and Q23. The voltage Vt1 increases from a negative value to a positive value.

Next, in MODE3, the switching elements Q11 and Q14 remain on, while the switching elements Q12 and Q13 remain off. The switching elements Q21 and Q24 switch from off to on, while the switching elements Q22 and Q23 switch from on to off. The polarity of the current IL12 is positive, and the current flows through the parasitic diodes of the switching elements Q22 and Q23. The voltage Vt2 increases from a negative value to a positive value. Due to the switching elements Q21 and Q24 being on, current also flows through the switching elements Q21 and Q24 in MODE3, but this is omitted for convenience.

Next, in MODE4, the switching elements Q11 and Q14 switch from on to off, while the switching elements Q12 and Q13 switch from off to on. Switching elements Q21, Q24 are kept on and switching elements Q22, Q23 are kept off. Since the polarity of the current IL12 is negative, current flows through the switching elements Q21, Q24. The voltage Vt1 falls from a positive value to a negative value.

An example in which the control circuit 71 controls the phase of voltage Vt2 to be lagging relative to voltage Vt1 has been shown, but it is not limited to this example. The control circuit 71 may control the phase of voltage Vt2 to be leading or in-phase relative to voltage Vt1.

An example where the power command is a positive value has been shown, but it is not limited to this example. The power command can be negative or zero. In the case of a negative value, it is also possible to transmit power from the second bridge circuit 32 to the first bridge circuit 31 via the inductance element 50.

### Summary of First Embodiment

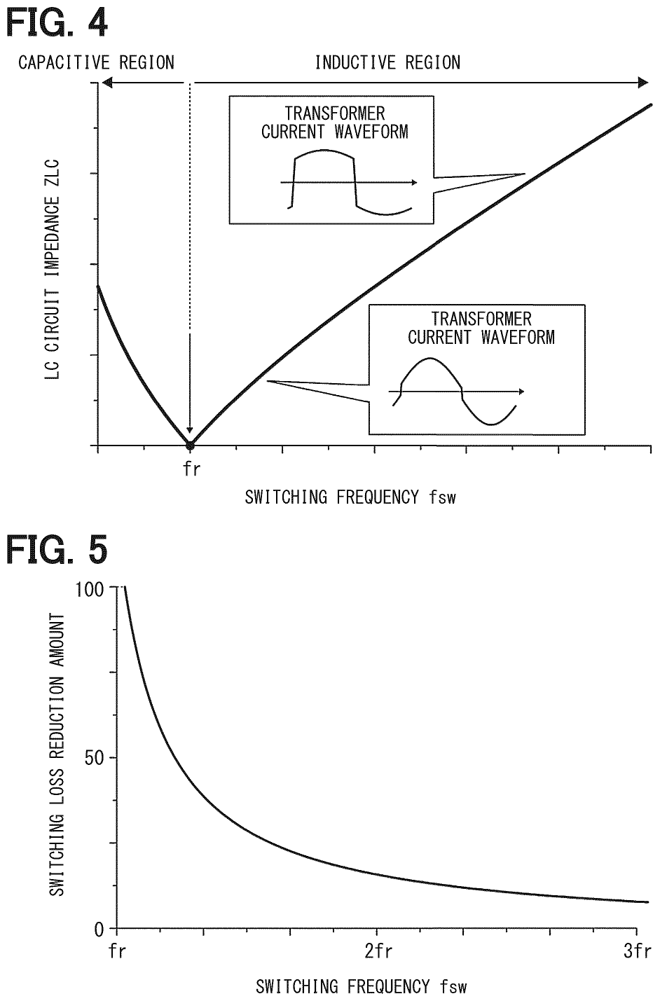

FIG. 4 shows the relationship between the switching frequency fsw and the impedance ZLC of the LC circuit. As shown in FIG. 4, the region with frequencies lower than the resonant frequency fr is the capacitive region, and the region with frequencies higher than the resonant frequency fr is the inductive region. The impedance ZLC of the LC circuit decreases with the increase in the switching frequency fsw in the capacitive region and becomes minimum at the resonant frequency fr. The impedance ZLC increases with the increase in the switching frequency fsw in the inductive region.

As shown in FIG. 4, in the inductive region, the waveform of the transformer current approaches a sinusoidal shape. The closer it is to the resonant frequency fr, the more the waveform approximates a sinusoidal shape. In the present embodiment, the controller 70 (control circuit 71) drives the switching elements Q11 to Q14, Q21 to Q24, and Q31 to Q34 at a switching frequency fsw higher than the resonant frequency fr of the closed-loop circuit. In this way, by driving the switching elements Q11 to Q14, Q21 to Q24, and Q31 to Q34 in the inductive region, the current waveform approaches a sinusoidal shape.

FIG. 5 shows the relationship between the switching frequency fsw and the reduction in switching losses in a configuration that includes a capacitor 60. FIG. 5 shows a simulation result. As shown in FIG. 5, by setting the switching frequency fsw higher than the resonant frequency fr, switching losses can be reduced. The reduction in switching losses decreases as the switching frequency fsw increases. The reduction in switching losses is greater when closer to the resonant frequency fr. Therefore, it may preferable to set the switching frequency fsw within the range of 1.3 times to 2 times the resonant frequency fr.

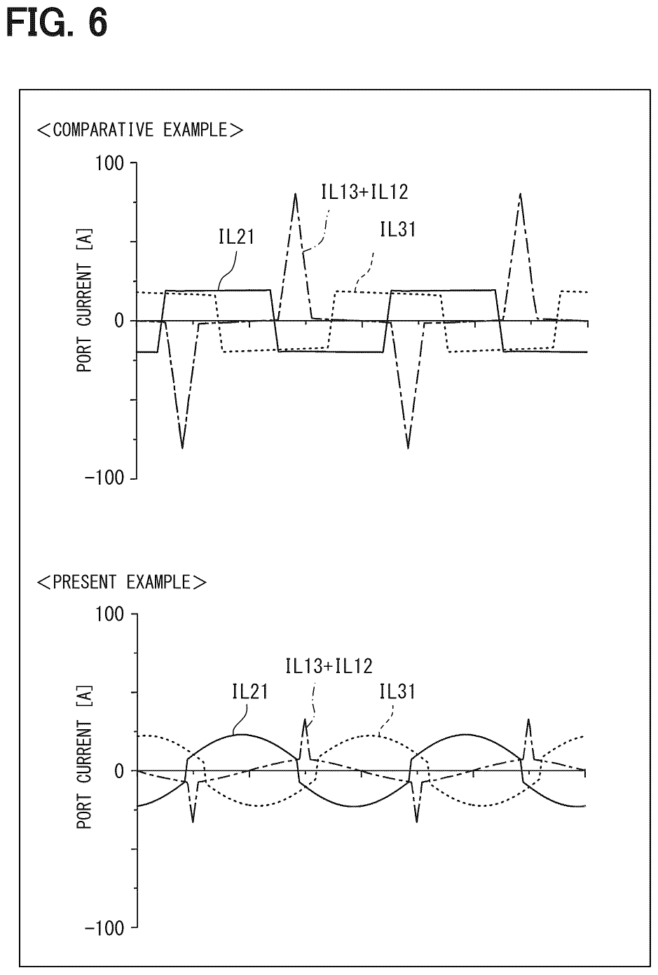

FIG. 6 shows the simulation results of the port current waveform. FIG. 6 shows the port current waveform during the power transmission operation from the second terminal 22 to the third terminal 23. In FIG. 6, a comparison is made between a comparative example and the present example (an example of this embodiment). The comparative example differs from the present example in that it does not include a capacitor 60, while the other configurations are the same as in the present example. The solid line shown in FIG. 6 represents the port current IL21 of the second bridge circuit 32, and the dashed line represents the port current IL31 of the third bridge circuit 33. The one-dot chain line represents the port current of the first bridge circuit 31, that is, the sum of the currents IL13 and IL12. The one-dot chain line represents the current flowing through the connection point A1 in FIG. 1. As shown in FIG. 6, in the comparative example, the peak value of the port current of the first bridge circuit 31 is large. In the present example, the peak value of the port current of the first bridge circuit 31 can be reduced by approximately 60% compared to the comparative example.

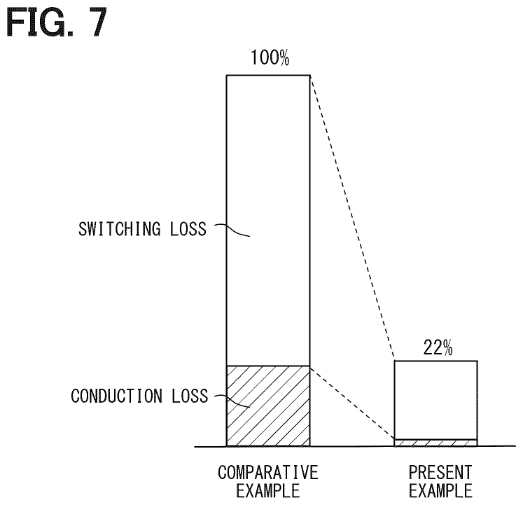

FIG. 7 shows the simulation results of the semiconductor losses. Similar to FIG. 6, FIG. 7 shows the semiconductor losses of the first bridge circuit 31 during the power transmission operation from the second terminal 22 to the third terminal 23. FIG. 7 also compares the present example, which includes a capacitor 60, with the comparative example, which does not include a capacitor 60. In the comparative example, the semiconductor losses of the first bridge circuit 31 are large. In the present example, the semiconductor losses of the first bridge circuit 31 can be reduced by approximately 78% compared to the comparative example.

In the present embodiment, the capacitor 60 is connected in the closed-loop circuit between at least one of the AC terminals of the two bridge circuits 30 and the inductance element 50. As an example, the power converter 10 includes three bridge circuits 30, each provided with a capacitor 60 in their respective closed-loop circuits. Then, the controller 70 drives the switching elements Q11 to Q14, Q21 to Q24, and Q31 to Q34 at a switching frequency fsw higher than the resonant frequency fr of the closed-loop circuit. As a result, as shown in FIGS. 4 and 6, the current waveform approaches a sinusoidal shape. Therefore, the current value during switching, and consequently the semiconductor losses, can be reduced. Since the current value during switching becomes smaller, the conversion efficiency can be increased over a wide range from light load to rated load regions.

Similarly, the program 713 (control program) stored in the memory 711 causes at least one processor 712 (processing unit) to set a switching frequency fsw that is higher than the resonant frequency fr of the closed-loop circuit. The program 713 causes the processor 712 to drive the switching elements Q11 to Q14, Q21 to Q24, and Q31 to Q34 at the set switching frequency. As a result, similar to the above, the current waveform approaches a sinusoidal shape. Therefore, the current value during switching can be reduced. As a result, the conversion efficiency of the power conversion device 10 can be increased over a wide range from the light load region to the rated load region.

As shown in FIG. 5, the switching frequency fsw only needs to be higher than the resonant frequency fr. The switching frequency fsw may be preferably set within a range of 1.3 to 2 times the resonant frequency fr. As shown in FIG. 4, the closer the current waveform is to the resonant frequency fr, the closer it approaches a sine wave. In other words, the current value during switching can be reduced. By setting the switching frequency fsw within a range of 1.3 to 2 times the resonant frequency fr, stable power conversion can be achieved while effectively reducing switching losses (semiconductor losses).

### Modification

An example in which the resonant frequencies of the closed-loop circuits are equal to each other in a configuration having three or more bridge circuits 30 has been shown, but it is not limited to this example. For example, in the configuration shown in FIG. 1, the capacitance values of capacitors 61 and 62 may be made different, thereby allowing the resonant frequencies of the closed-loop circuits to differ. The controller 70 should drive the switching elements Q11 to Q14, Q21 to Q24, and Q31 to Q34 at a switching frequency fsw that is higher than the highest resonant frequency fr of the closed-loop circuits.

The arrangement of the capacitor 60 is not limited to that in the above-described example. In the closed-loop circuit, placement is possible between the AC terminal and the inductance element 50. For example, the first capacitor 61 may be provided between the AC terminal on the side of the switching elements Q13 and Q14 and the end of the first coil 511. It may be provided between the AC terminal on the side of the switching elements Q21 and Q22 and the end of the second coil 512. It may be provided between the AC terminal on the side of the switching elements Q23 and Q24 and the end of the second coil 512. The same applies to the second capacitor 62.

### Second Embodiment

This embodiment is a modification based on the preceding embodiment, and the description of the preceding embodiment can be incorporated. In the preceding embodiment, each of the bridge circuits 30 had two series circuits. Instead, the number of series circuits may be a number other than two.

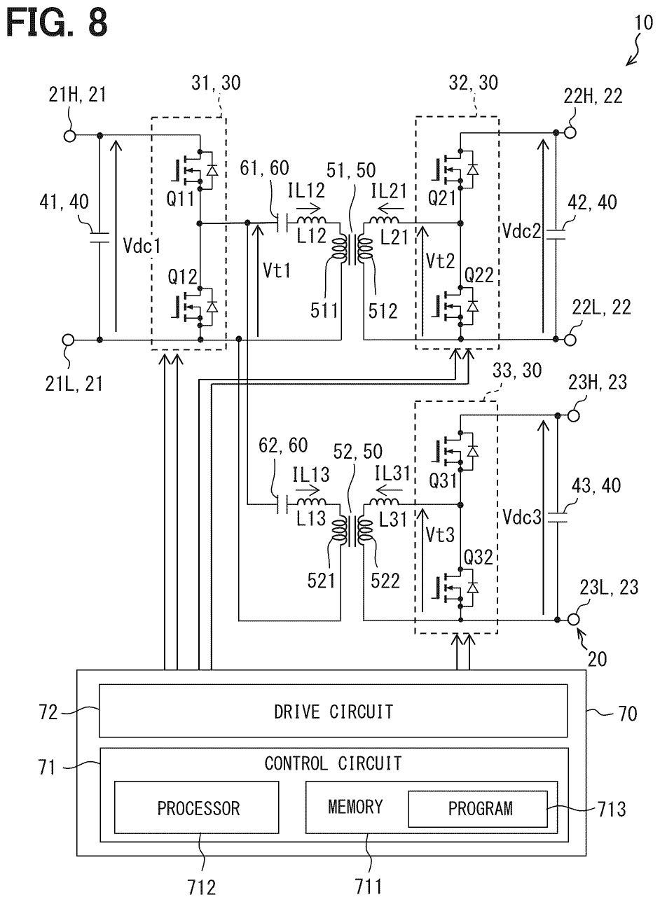

FIG. 8 shows the power converter 10 according to the present embodiment. Similar to the preceding embodiment, the power converter 10 includes three bridge circuits 30. Each of the bridge circuits 30 has only one series circuit. The bridge circuit 30 is sometimes referred to as a half-bridge circuit.

The first bridge circuit 31 has only a series circuit of switching elements Q11 and Q12. A first capacitor 61 is connected between the AC terminal on the side of the switching elements Q11 and Q12 and one end of the first coil 511 of the first transformer 51. The other end of the first coil 511 is connected to the source of the low-side switching element Q12.

The second bridge circuit 32 has only a series circuit of switching elements Q21 and Q22. One end of the second coil 512 of the first transformer 51 is connected to the AC terminal on the side of the switching elements Q21 and Q22, and the other end is connected to the source of the low-side switching element Q22.

The third bridge circuit 33 has only a series circuit of switching elements Q31 and Q32. One end of the second coil 522 of the second transformer 52 is connected to the AC terminal on the side of the switching elements Q31 and Q32. A second capacitor 62 is connected between one end of the first coil 521 and the AC terminal on the side of the switching elements Q11 and Q12. The other end of the first coil 521 is connected to the source of the low-side switching element Q12.

In the above-mentioned configuration, the control unit 70 drives the switching elements Q11 to Q14, Q21 to Q24, and Q31 to Q34 at a switching frequency fsw higher than the resonant frequency fr of the closed-loop circuit. The other configurations are the same as those of the power converter 10 described in the preceding embodiment.

### Summary of Second Embodiment

Even in the present embodiment, the power converter 10 includes three bridge circuits 30, each provided with a capacitor 60 in their respective closed-loop circuits. Then, the controller 70 drives the switching elements Q11 to Q14, Q21 to Q24, and Q31 to Q34 at a switching frequency fsw higher than the resonant frequency fr of the closed-loop circuit. Thus, an effect equivalent to that of the configuration described in the preceding embodiment can be achieved. Specifically, as the current waveform approaches a sine wave, the current value during switching can be reduced. And the conversion efficiency can be improved over a wide range from light load to rated load regions.

An example has been shown where each of the bridge circuits 30 has one series circuit, but it may also have three series circuits.

### Third Embodiment

This embodiment is a modification based on the preceding embodiment, and the description of the preceding embodiment can be incorporated. In the preceding embodiment, the power converter 10 was equipped with two inductance elements 50. Instead, the number of inductance elements 50 may be three or more.

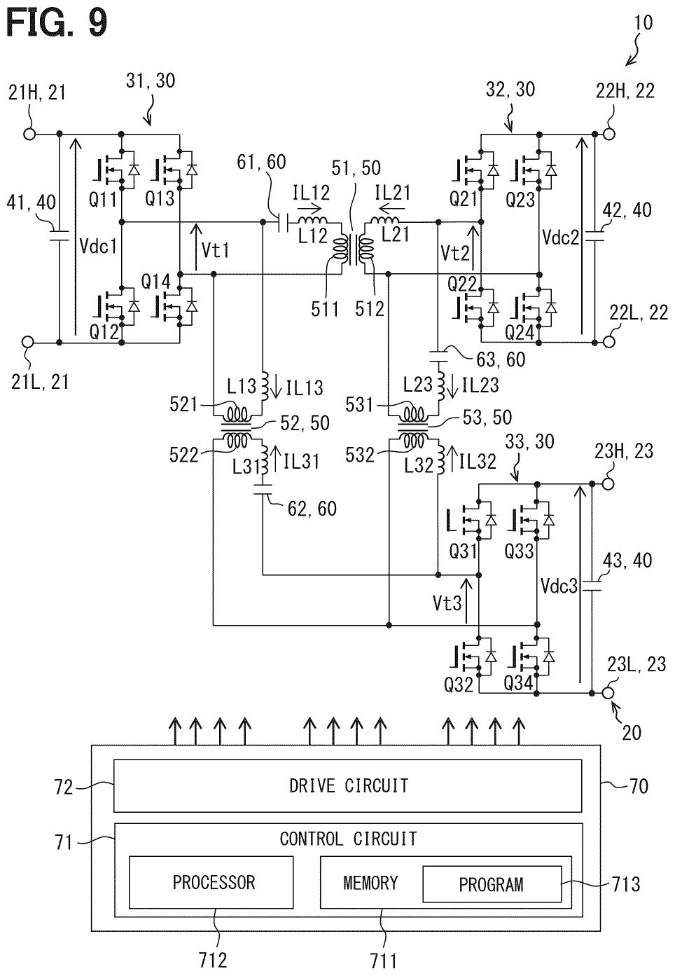

FIG. 9 shows the power converter 10 according to the present embodiment. In FIG. 9, for convenience, the communication lines of the controller 70 are shown in a simplified manner. As in the first embodiment, the power converter 10 is equipped with three bridge circuits 30 having a full bridge configuration. The power converter 10 includes three inductance elements, specifically, a first transformer 51, a second transformer 52, and a third transformer 53. The power converter 10 includes three capacitors 60, specifically, a first capacitor 61, a second capacitor 62, and a third capacitor 63.

The first transformer 51, the second transformer 52, and the first capacitor 61 have an arrangement similar to the first embodiment. The second capacitor 62 is connected between the end of the second coil 522 of the second transformer 52 and the AC terminals on the side of the switching elements Q31 and Q32 of the third bridge circuit 33.

The third transformer 53 is connected between the AC terminal of the second bridge circuit 32 and the AC terminal of the third bridge circuit 33. The third transformer 53 has a configuration similar to that of the first transformer 51 and the second transformer 52. The first coil 531 of the third transformer 53 is connected to the AC terminals of the second bridge circuit 32. One end of the first coil 531 is connected to the AC terminals of the series circuit of switching elements Q21 and Q22, and the other end is connected to the AC terminals of the series circuit of switching elements Q23 and Q24. The second coil 532 is connected to the AC terminals of the third bridge circuit 33. One end of the second coil 532 is connected to the AC terminals of the series circuit of switching elements Q31 and Q32, and the other end is connected to the AC terminals of the series circuit of switching elements Q33 and Q34.

The inductances L23 and L32 shown in FIG. 9 are the leakage inductances of the third transformer 53. The inductances L23, L32 are equivalent. The inductances L12, L13, L21, L23, L31, L32 are equal to each other. The current IL23 is the current flowing through the inductance L23, that is, the first coil 531. The current IL32 is the current flowing through the inductance L32, that is, the second coil 532.

The third capacitor 63 is connected between the AC terminals on the side of switching elements Q21 and Q22 in the second bridge circuit 32 and the first coil 531. The third capacitor 63 forms an LC series resonant circuit with the inductances L23 and L32, which are the leakage inductances of the third transformer 53. As an example, the capacitance values of the first capacitor 61, the second capacitor 62, and the third capacitor 63 are equal to each other. Therefore, the resonant frequencies in all the closed-loop circuits of the power converter 10 are equal to each other.

The power converter 10 has six closed-loop circuits. One of the closed-loop circuits includes the first bridge circuit 31, the first transformer 51, and the second bridge circuit 32. Another of the closed-loop circuits includes the first bridge circuit 31, the second transformer 52, and the third bridge circuit 33. Another of the closed-loop circuits includes the second bridge circuit 32, the third transformer 53, and the third bridge circuit 33. Another of the closed-loop circuits includes the first bridge circuit 31, the second transformer 52, the third transformer 53, and the second bridge circuit 32. Another of the closed-loop circuits includes the first bridge circuit 31, the first transformer 51, the third transformer 53, and the third bridge circuit 33. Another of the closed-loop circuits includes the second bridge circuit 32, the first transformer 51, the second transformer 52, and the third bridge circuit 33. As an example, similar to the preceding embodiment, the resonant frequencies of all the closed-loop circuits are equal to each other.

In the aforementioned configuration, the controller 70 drives the switching elements Q11 to Q14, Q21 to Q24, and Q31 to Q34 at a switching frequency fsw higher than the resonant frequency fr of the closed-loop circuits. The other configuration is the same as the power converter 10 described in the first embodiment.

### Summary of Third Embodiment

Even in the present embodiment, the power converter 10 includes three bridge circuits 30, each provided with a capacitor 60 in their respective closed-loop circuits. Then, the controller 70 drives the switching elements Q11 to Q14, Q21 to Q24, and Q31 to Q34 at a switching frequency fsw higher than the resonant frequency fr of the closed-loop circuit. Thus, an effect equivalent to that of the configuration described in the preceding embodiment can be achieved. Specifically, as the current waveform approaches a sinusoidal wave, the current value during switching can be reduced. And the conversion efficiency can be improved over a wide range from light load to rated load regions.

The power converter 10 requires at least a number of inductance elements 50 (transformers) that is one less than the number of bridge circuits 30. As shown in the present embodiment, the inductance elements 50 may be arranged that are equal to or greater than the number of bridge circuits 30.

The configuration described in the present embodiment can be combined with either the configuration described in the first embodiment or the configuration described in the second embodiment.

### Fourth Embodiment

This embodiment is a modification based on the preceding embodiment, and the description of the preceding embodiment can be incorporated. In the preceding embodiment, the power converter 10 includes three external connection terminals 20 and a bridge circuit 30. Instead, four or more external connection terminals 20 and bridge circuits 30 may be provided. In other words, it may be configured with more than four ports.

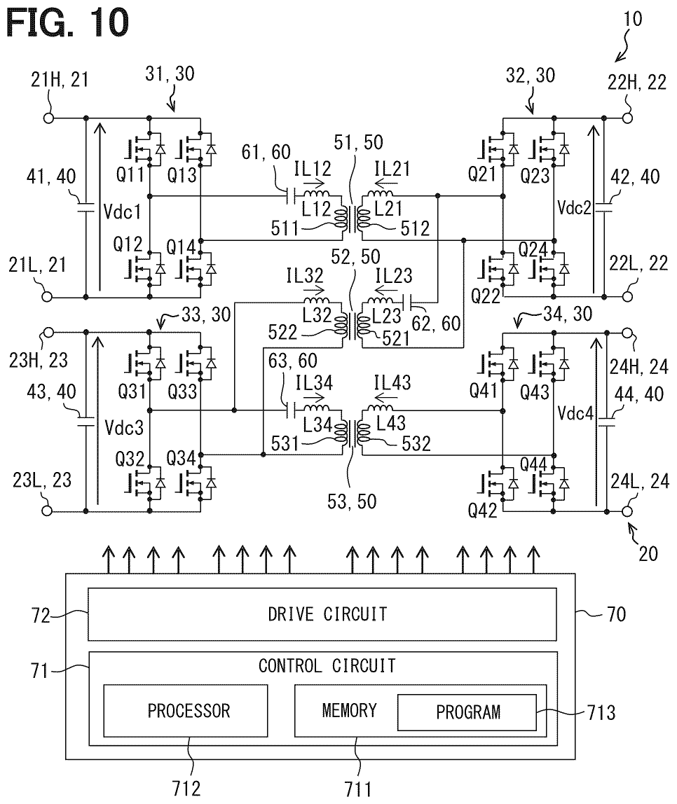

FIG. 10 illustrates a circuitry structure of a power converter 10 according to the present embodiment. In FIG. 10, the communication line of the controller 70 is omitted for convenience. The power converter 10 has four external connection terminals 20 and four bridge circuits 30 in a full bridge configuration. In contrast to the preceding embodiment, the power converter 10 further includes a fourth terminal 24, a fourth smoothing capacitor, and a fourth bridge circuit 34. The fourth terminal 24 includes a fourth terminal 24H on the high potential side and a fourth terminal 24L on the low potential side. The fourth bridge circuit 34 includes switching elements Q41, Q42, Q43, and Q44. The switching elements Q41, Q42 form a series circuit with the switching element Q41 as the high-side. The switching elements Q43, Q44 form a series circuit with the switching element Q43 as the high-side.

The power converter 10 includes three inductance elements, specifically, a first transformer 51, a second transformer 52, and a third transformer 53. The power converter 10 includes three capacitors 60, specifically, a first capacitor 61, a second capacitor 62, and a third capacitor 63.

The first transformer 51 is connected between the AC terminal of the first bridge circuit 31 and the AC terminal of the second bridge circuit 32. The first capacitor 61 is connected between the AC terminal on the side of the switching elements Q11 and Q12 and the end of the first coil 511.

The second transformer 52 is connected between the AC terminal of the second bridge circuit 32 and the AC terminal of the third bridge circuit 33. The second capacitor 62 is connected between the AC terminal on the side of the switching elements Q21 and Q22 and the end of the first coil 521.

The third transformer 53 is connected between the AC terminal of the third bridge circuit 33 and the AC terminal of the fourth bridge circuit 34. The third capacitor 63 is connected between the AC terminals on the switching elements Q31, Q32 and the ends of the first coil 531.

The inductances L23, L32 shown in FIG. 10 are the leakage inductances of the second transformer 52. The inductances L34, L43 are the leakage inductances of the third transformer 53. The inductances L12, L21, L23, L32, L34, L43 are equal to each other. The current IL34 is the current flowing through the inductance L34. The current IL43 is the current flowing through the inductance L43.

The power converter 10 has six closed-loop circuits. One of the closed-loop circuits includes the first bridge circuit 31, the first transformer 51, and the second bridge circuit 32. Another closed-loop circuit includes the second bridge circuit 32, the second transformer 52, and the third bridge circuit 33. Another closed-loop circuit includes the third bridge circuit 33, the third transformer 53, and the fourth bridge circuit 34. Another one of the closed-loop circuits includes the first bridge circuit 31, the first transformer 51, the second transformer 52, and the third bridge circuit 33. Another one of the closed-loop circuits includes the second bridge circuit 32, the second transformer 52, the third transformer 53, and the fourth bridge circuit 34. Another one of the closed-loop circuits includes the first bridge circuit 31, the first transformer 51, the second transformer 52, the third transformer 53, and the fourth bridge circuit 34. As an example, similar to the preceding embodiment, the resonant frequencies of all the closed-loop circuits are equal to each other.

In the aforementioned configuration, the controller 70 drives the switching elements Q11 to Q14, Q21 to Q24,Q31 to Q34 and Q41 to Q44 at a switching frequency fsw higher than the resonant frequency fr of the closed-loop circuits. The other configuration is the same as the power converter 10 described in the first embodiment.

### Summary of Fourth Embodiment

In the present embodiment, the power converter 10 has four bridge circuits 30, and a capacitor 60 is provided in each closed-loop circuit. Then, the controller 70 drives the switching elements Q11 to Q14, Q21 to Q24, Q31 to Q34, Q41 to Q44 at a switching frequency fsp that is higher than the resonant frequency Fr of the closed-loop circuit. Thus, an effect equivalent to that of the configuration described in the preceding embodiment can be achieved. Specifically, as the current waveform approaches a sine wave, the current value during switching can be reduced. And the conversion efficiency can be improved over a wide range from light load to rated load regions.

The configuration described in the present embodiment can be combined with any of the configuration described in the first embodiment, the configuration described in the second embodiment, and the configuration described in the third embodiment.

### Fifth Embodiment

This embodiment is a modification based on the preceding embodiment, and the description of the preceding embodiment can be incorporated. In the preceding embodiment, the AC voltages output by each bridge circuit 30, such as voltages Vt1 and Vt2, are two-level voltages with positive and negative values. Instead, the output voltage of the bridge circuit 30 may be a three-level voltage being positive, zero, and negative values.

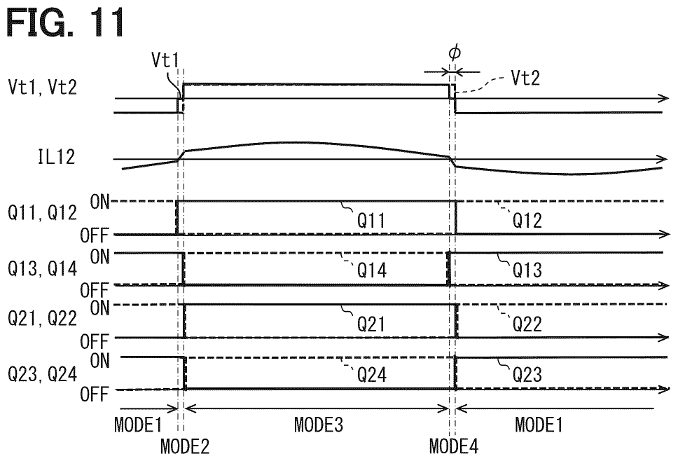

FIG. 11 illustrates the switching operation and the current and voltage waveforms in the power converter 10 according to the present embodiment. FIG. 11 corresponds to FIG. 2. In FIG. 11, the phase of the output voltage Vt2 of the second bridge circuit 32 lags behind the output voltage Vt1 of the first bridge circuit 31. FIG. 11 shows the operation of transmitting power from the first bridge circuit 31 to the second bridge circuit 32.

The output voltage Vt1 is a three-level voltage with positive, zero, and negative values. The output voltage Vt2 is a two-level voltage with positive and negative values. The output voltage Vt1 outputs a positive value when the switching elements Q11, Q14, Q21, and Q24 are turned on. The output voltage Vt1 outputs a negative value when the switching elements Q12, Q13, Q22, and Q23 are turned on. The output voltage Vt1 outputs a zero value when the switching elements Q11 and Q13 are turned on. Alternatively, the output voltage Vt1 may output a zero value when the switching elements Q22 and Q24 are turned on.

The controller 70, similar to the preceding embodiment, controls the amount of power transmission between the first bridge circuit 31 and the second bridge circuit 32 by varying the phase difference φ. Other configurations are similar to those described in the preceding embodiment.

### Summary of Fifth Embodiment

In the present embodiment as well, the controller 70 drives the switching elements Q11 to Q14, Q21 to Q24, and Q31 to Q34 at a switching frequency fsw higher than the resonant frequency fr of the closed-loop circuit. Thus, an effect equivalent to that of the configuration described in the preceding embodiment can be achieved.

The configuration described in this embodiment can be combined with the configuration described in the first embodiment, the configuration described in the second embodiment, the configuration described in the third embodiment, and the configuration described in the fourth embodiment.

An example of making the output voltage Vt1 a three-level voltage has been shown, but it is not limited to this example. The output voltage Vt2 may also be a three-level voltage. The output voltages Vt1 and Vt2 may also be three-level voltages.

### Sixth Embodiment

This embodiment is a modification based on the preceding embodiment, and the description of the preceding embodiment can be incorporated. In the preceding embodiment, the power converter 10 has three or more external connection terminals 20 and a bridge circuit 30. Instead, two external connection terminals 20 and a bridge circuit 30 may be provided. In other words, it may be a two-port configuration.

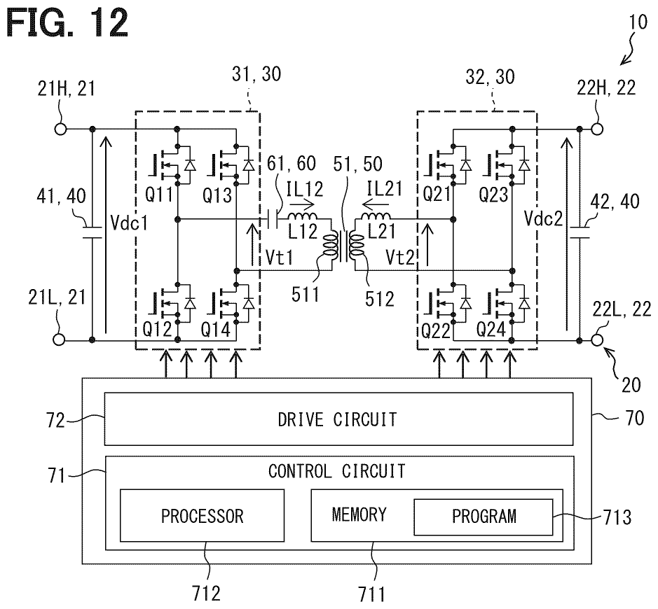

FIG. 12 illustrates the power converter 10 according to the present embodiment. The power converter 10 includes two external connection terminals 20, specifically a first terminal 21 and a second terminal 22. The power converter 10 includes two bridge circuits 30, specifically a first bridge circuit 31 and a second bridge circuit 32.

The power converter 10 has a configuration in which the third terminal 23, the third bridge circuit 33, the third smoothing capacitor 43, the second transformer 52, and the second capacitor 62 are excluded from the configuration described in the first embodiment (see FIG. 1). The power converter 10 includes a first transformer 51 and a first capacitor 61. In the following, the first transformer 51 may be referred to as a transformer 51 and the first capacitor 61 may be referred to as a capacitor 61.

The transformer 51, which is an inductance element 50, is connected between the AC terminal of the first bridge circuit 31 and the AC terminal of the second bridge circuit 32. The capacitor 61 is connected between the AC terminal on the side of the switching elements Q11 and Q12 and the first coil 511.

The power converter 10 has a closed-loop circuit that includes the first bridge circuit 31, the transformer 51, and the second bridge circuit 32. A capacitor 61 is provided in this closed-loop circuit. The controller 70 drives the switching elements Q11 to Q14, Q21 to Q24 as in the first embodiment (see FIGS. 2 and 3). The controller 70 drives the switching elements Q11 to Q14 and Q21 to Q24 at a switching frequency fsw higher than the resonant frequency fr of the closed-loop circuit. Other configurations are similar to those described in the first embodiment.

### Summary of Sixth Embodiment

In this embodiment, the power conversion device 10 includes two bridge circuits 30, and in the closed-loop circuit, a capacitor 61 is connected between the AC terminal of the bridge circuit 30 and the transformer 51. And the controller 70 drives the switching elements Q11 to Q14 and Q21 to Q24 at a switching frequency fsw higher than the resonant frequency fr of the closed-loop circuit. As a result, it is possible to achieve effects equivalent to those of the preceding embodiment. Specifically, the current waveform approaches the sine waveform. Therefore, the current value during switching, and consequently the semiconductor losses, can be reduced. Since the current value during switching becomes smaller, the conversion efficiency can be increased over a wide range from light load to rated load regions.

Additionally, the program 713 (control program) stored in the memory 711 causes at least one processor 712 (processing unit) to set a switching frequency fsw that is higher than the resonant frequency fr of the closed-loop circuit. The program 713 causes the processor 712 to drive the switching elements Q11 to Q14 and Q21 to Q24 at the set switching frequency. As a result, similar to the above, the current waveform approaches a sinusoidal shape. Therefore, the current value during switching can be reduced. As a result, the conversion efficiency of the power conversion device 10 can be increased over a wide range from the light load region to the rated load region.

Similar to the preceding embodiment, in this embodiment as well, it is advisable to set the switching frequency fsw within a range of 1.3 times to 2 times the resonant frequency fr. As a result, it is possible to achieve stable power conversion while effectively reducing switching losses (semiconductor losses).

### Modification

The arrangement of the capacitor 61 is not limited to that in the above-described example. The first capacitor 61 may be provided between the AC terminal on the side of the switching elements Q13 and Q14 and the end of the first coil 511. It may be provided between the AC terminal on the side of the switching elements Q21 and Q22 and the end of the second coil 512. It may be provided between the AC terminal on the side of the switching elements Q23 and Q24 and the end of the second coil 512.

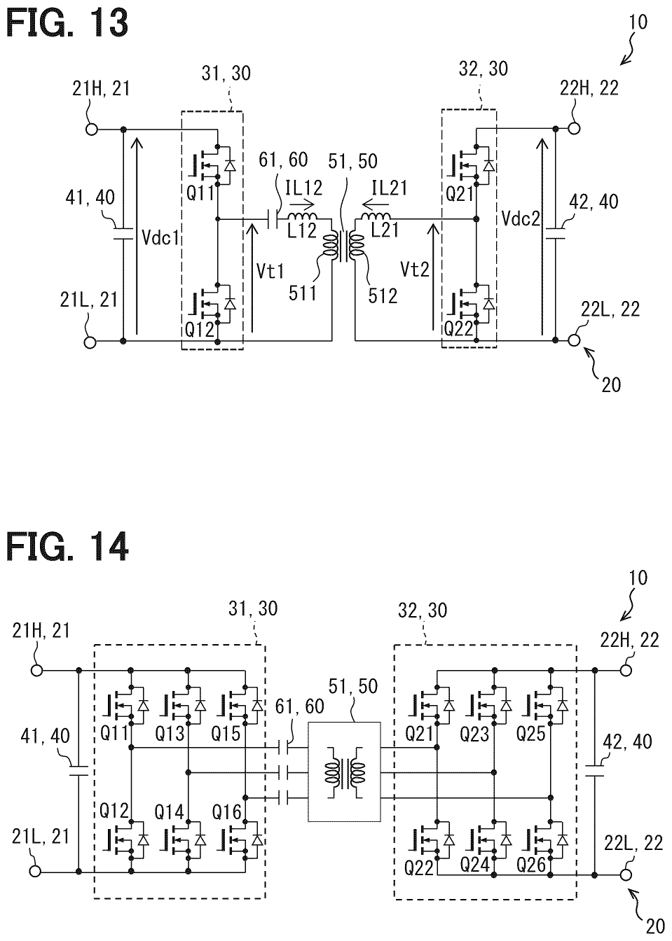

The configuration of the two bridge circuits 30 is not limited to a full bridge. For example, as shown in FIG. 13, a bridge circuit 30 having a half-bridge configuration may be adopted. The first bridge circuit 31 has only the series circuit of the switching elements Q11 and Q12. The second bridge circuit 32 has only the series circuit of the switching elements Q21 and Q22. One end of the first coil 511 is connected to the source of the switching element Q12. One end of the second coil 512 is connected to the source of the switching element Q22.

As shown in FIG. 14, the bridge circuit 30 may have three or more series circuits The first bridge circuit 31 has a series circuit of the switching elements Q11 and Q12, a series circuit of the switching elements Q13 and Q14, and a series circuit of the switching elements Q15 and Q16. The second bridge circuit 32 has a series circuit of the switching elements Q21 and Q22, a series circuit of the switching elements Q23 and Q24, and a series circuit of the switching elements Q25 and Q26. Such a bridge circuit 30 is sometimes referred to as a three-leg circuit. The transformer 51 is converting single-phase to three-phase. The capacitor 61 is provided between each of the three AC terminals and the transformer 51. In the modified examples in FIGS. 13 and 14, the controller 70 is omitted for convenience.

The configuration described in this embodiment can be combined with the configuration described in the fifth embodiment. The number of transformers 51 is not limited to one. Two or more transformers 51 may be provided.

### Seventh Embodiment

This embodiment is a modification based on the preceding embodiment, and the description of the preceding embodiment can be incorporated. In the preceding embodiment, the capacitor 60 is provided between the AC terminal of one of the bridge circuits 30 and the inductance element 50 in the two bridge circuits 30 and the inductance element 50 that form the closed-loop circuit. Instead, the capacitor 60 may be provided between each of the bridge circuits 30 and the inductance element 50.

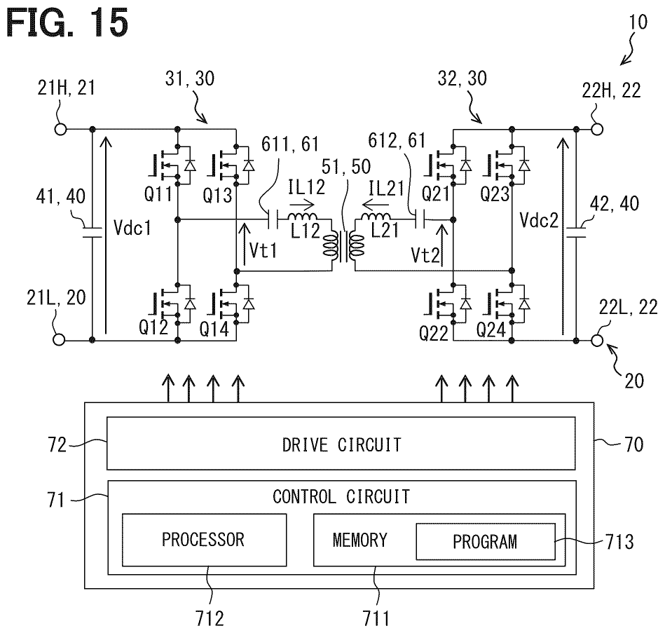

FIG. 15 shows the power converter 10 according to the present embodiment. For convenience, in FIG. 15, the communication lines of the controller 70 are simplified. The basic configuration of the power converter 10 is the same as the configuration described in the sixth embodiment (see FIG. 12). The power converter 10 has two capacitors 611 and 612, as the capacitor 61 provided in the closed-loop circuit including the first bridge circuit 31, the transformer 51, and the second bridge circuit 32. The capacitor 611 is connected between the AC terminals on the side of the switching elements Q11 and Q12 and the transformer 51. The capacitor 612 is connected between the AC terminals on the side of the switching elements Q21 and Q22 and the transformer 51.

In this manner, two capacitors 61 (611 and 612) are arranged in series in the closed-loop circuit. The control unit 70 drives the switching elements Q11 to Q14 and Q21 to Q24 at a switching frequency fsw, which is higher than the resonant frequency fr of the closed-loop circuit.

### Summary of Seventh Embodiment

In the present embodiment, the capacitor 61 is provided on each of both sides of the transformer 51. As a result, in addition to the effects described in the preceding embodiment, it is possible to achieve the effect of suppressing transformer core saturation (magnetization bias). Therefore, it becomes possible to perform power conversion operations more stably.

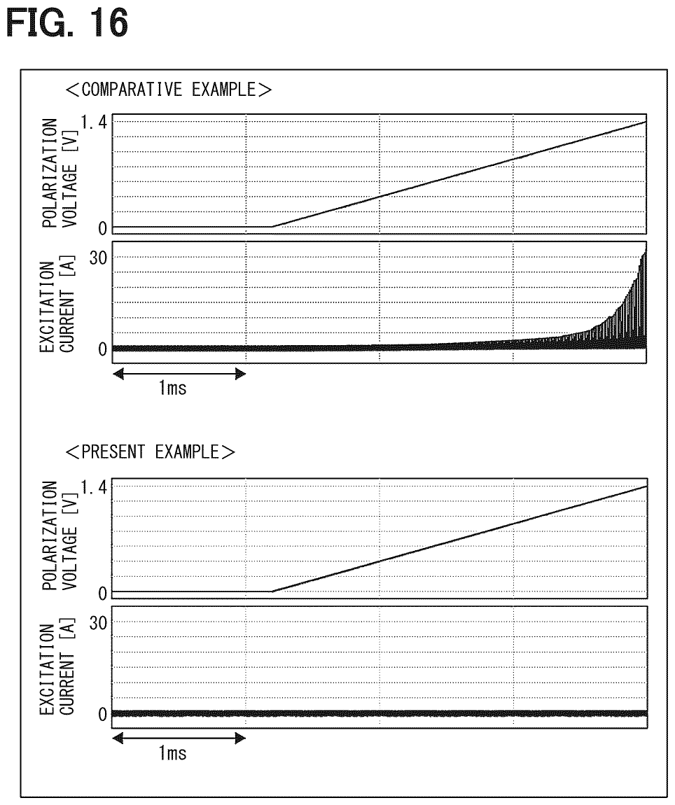

FIG. 16 illustrates the effect of transformer polarization suppression. FIG. 16 shows a simulation result. The comparative example shown in FIG. 16 illustrates the results of a configuration in which the capacitor 61 is provided on one side (for example, the primary side) of the transformer 51. In other words, it shows the results of the configuration described in the sixth embodiment (see FIG. 12). The present example shows the results of the configuration of the present embodiment, in which capacitors 61 are provided on both sides of the transformer 51.

In the comparative example, the excitation current increases after a DC voltage is superimposed on the transformer 51. And eventually, the transformer 51 becomes saturated. In the present example, by providing capacitors 61 on both sides of the transformer 51, it is possible to cancel out the DC components in both directions. This makes it possible to suppress the increase in excitation current, and consequently, to suppress the saturation of the transformer 51.

### Modification

The capacitor 61 may be placed at least one between the AC terminal of one of the two bridge circuits 30 and the inductance element 50, and at least one between the AC terminal of the other of the two bridge circuits 30 and the inductance element 50.

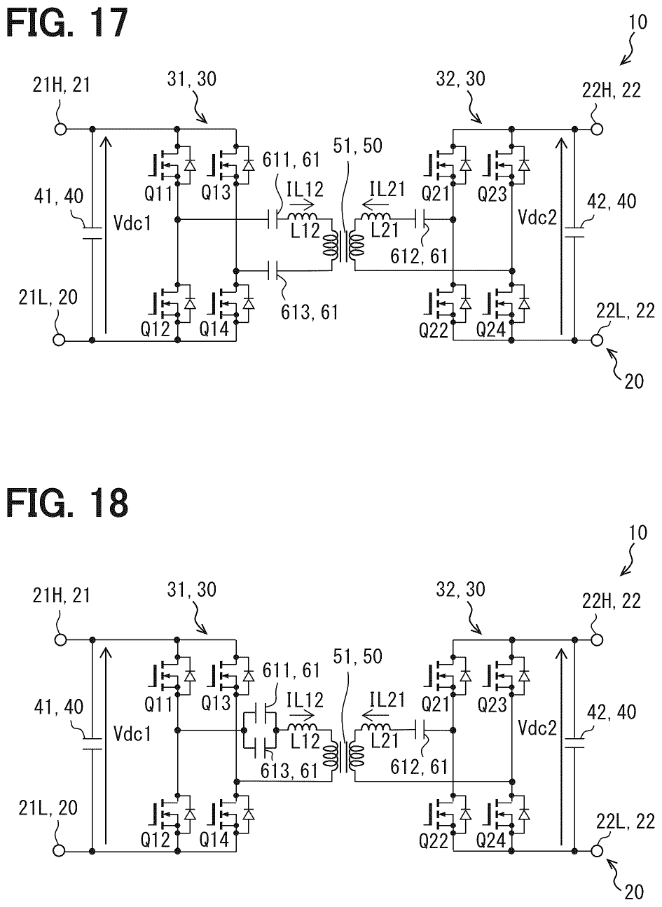

For example, in the case shown in FIG. 17, a capacitor 613 is added to the configuration shown in FIG. 15. The capacitor 613 is connected between the AC terminal on the side of the switching elements Q13 and Q14 and the transformer 51. In this way, it is also possible to place multiple capacitors 61 on the side of the first bridge circuit 31. It is also possible to place multiple capacitors 61 on the side of the second bridge circuit 32, or to place multiple capacitors 61 on both sides of the transformer 51, respectively. In other words, the number of capacitors 61 arranged in series in the closed-loop circuit may be three or more. Even with such a configuration, it is possible to achieve the same transformer bias suppression effect as the configuration shown in FIG. 15.

In the example shown in FIG. 18, the added capacitor 613 is connected in parallel with capacitor 611, compared to the configuration shown in FIG. 15. It is also possible to place the parallel circuit of capacitors 61 on the side of the second bridge circuit 32, or to place parallel circuits of capacitors 61 on both sides of the transformer 51 Even with such a configuration, it is possible to achieve the same transformer bias suppression effect as the configuration shown in FIG. 15. In the modified examples in FIGS. 17 and 18, the controller 70 is omitted for convenience.

The configuration described in this embodiment can be combined with the configurations described in the first embodiment, the second embodiment, the third embodiment, the fourth embodiment, the fifth embodiment, and the sixth embodiment.

### Eighth Embodiment

This embodiment is a modification based on the preceding embodiment, and the description of the preceding embodiment can be incorporated. In the preceding embodiment, the power converter 10 included a transformer as the inductance element 50. Instead, an inductor may be provided.

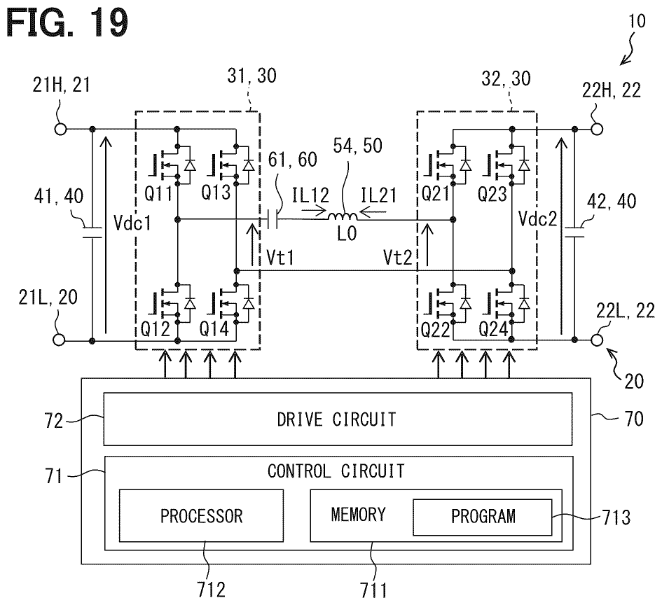

FIG. 19 shows the power converter 10 according to the present embodiment. The basic configuration of the power converter 10 is the same as the configuration described in the sixth embodiment (see FIG. 12). The power converter 10 includes an inductor 54 as the inductance element 50. The inductor 54 may be referred to as a reactor.

The inductor 54 is connected to the AC terminals of the two bridge circuits 30. One terminal of the inductor 54 is connected to the AC terminal on the side of the switching elements Q11 and Q12 of the first bridge circuit 31, and the other terminal is connected to the AC terminal on the side of the switching elements Q21 and Q22 of the second bridge circuit 32. L0 indicates the inductance of the inductor 54. The AC terminals on the side of the switching elements Q13 and Q14 of the first bridge circuit 31 are interconnected with the AC terminals on the side of the switching elements Q23 and Q24 of the second bridge circuit 32.

The closed-loop circuit includes the first bridge circuit 31, the inductor 54, and the second bridge circuit 32. The capacitor 61 is connected between the AC terminals on the side of the switching elements Q11 and Q12 and the inductor 54 within the closed-loop circuit. The control unit 70 drives the switching elements Q11 to Q14 and Q21 to Q24 at a switching frequency fsw, which is higher than the resonant frequency fr of the closed-loop circuit.

### Summary of Eighth Embodiment

In the present embodiment, an inductor 54 is used instead of a transformer 51. The inductor 54 does not have an isolation function like the transformer 51. However, by providing a capacitor 61 in the closed-loop circuit and driving the switching elements Q11 to Q14 and Q21 to Q24 at a switching frequency fsw that is higher than the resonant frequency fr of the closed-loop circuit, it is possible to achieve the same effects as in the preceding embodiment. Specifically, as the current waveform approaches a sine wave, the current value during switching can be reduced. This makes it possible to improve conversion efficiency over a wide range from light load conditions to rated load conditions.

The configuration described in this embodiment can be combined with the configurations described in the first embodiment, the second embodiment, the third embodiment, the fourth embodiment, the fifth embodiment, the sixth embodiment, and the seventh embodiment. For example, the transformers 51, 52, 53 may be replaced by inductors 54.

### Other Embodiments

The present disclosure in the specification, the drawings and the like is not limited to the embodiments exemplified hereinabove. The disclosure encompasses the illustrated embodiments and modifications by those skilled in the art based thereon. For example, the disclosure is not limited to the combinations of components and/or elements shown in the embodiments. The disclosure may be implemented in various combinations. The present disclosure may have additional parts that may be added to the embodiments. The present disclosure encompasses modifications in which components and/or elements are omitted from the embodiments. The present disclosure encompasses the replacement or combination of components and/or elements between one embodiment and another. The technical scopes disclosed in the present disclosure are not limited to the description of the embodiments. The several technical scopes disclosed are indicated by the description in the present disclosure, and should be further understood to include meanings equivalent to the description of the claims and all modifications within the scope.

The disclosure in the specification, drawings and the like is not limited by the technical scopes disclosed in the present disclosure. The disclosure in the specification, the drawings, and the like encompasses the technical ideas described in the technical scopes disclosed in the present disclosure, and further extends to a wider variety of technical ideas than those in the technical scopes disclosed in the present disclosure. Hence, various technical ideas can be extracted from the disclosure of the specification, the drawings, and the like without being bound by the description of the technical scopes disclosed in the present disclosure.

When an element or layer is referred to as being “on,” “coupled,” “connected,” or “combined,” it may be directly on, coupled, connected, or combined to the other element or layer, or further, intervening elements or layers may be present. In contrast, when an element is described as “directly disposed on,” “directly coupled to,” “directly connected to”, or “directly combined with” another element or another layer, there are no intervening elements or layers present. Other terms used to describe the relationships between elements (for example, “between” vs. “directly between”, and “adjacent” vs. “directly adjacent”) should be interpreted similarly. As used herein, the term “and/or” includes any combination and all combinations relating to one or more of the related listed items. For example, the term A and/or B includes only A, only B, or both A and B.

What is claimed is:

1. A power converter comprising:
external connection terminals, number of the external connection terminals being three or more;
bridge circuits connected to the external connection terminals, respectively;
an inductance element provided for each combination of arbitrary two of the bridge circuits, the inductance element connected between an AC terminal of one of the two bridge circuits and an AC terminal of another one of the two bridge circuits, the two bridge circuits configured to transfer power; and
a controller configured to drive switching elements included in the bridge circuits, wherein
the two of the bridge circuits and the inductance element are included in a closed-loop circuit,
the closed-loop circuit has a capacitor connected between the inductance element and at least one of respective AC terminals of the two bridge circuits, and
the controller is configured to drive the switching elements at a switching frequency higher than a maximum value of a resonant frequency of the closed-loop circuit.

2. The power converter according to claim 1, wherein
the switching frequency is within a range of 1.3 to 2 times of the resonant frequency.

3. The power converter according to claim 1, wherein
at least one capacitor is connected between the inductance element and the AC terminal of the one of the two bridge circuits, and at least one capacitor is connected between the inductance element and the AC terminal of the other one of the two bridge circuits.

4. The power converter according to claim 1, wherein
the inductance element is a transformer.

5. The power converter according to claim 1, wherein
the inductance element is an inductor.

6. A non-transitory computer readable medium configured to be adapted to a power converter, the non-transitory computer readable medium storing a computer program product comprising instructions configured to, when executed by at least one processor, cause the at least one processor to:
set a switching frequency higher than a maximum value of a resonant frequency of a closed-loop circuit of the power converter, the closed-loop circuit including arbitrary two of bridge circuits and an inductance element, the inductance element connected between an AC terminal of one of the arbitrary two of the bridge circuits and an AC terminal of another one of the arbitrary two of the bridge circuits, the closed-loop circuit further including a capacitor connected between the inductance element and at least one of respective AC terminals of the two bridge circuits, the bridge circuits connected to more than three external connection terminals, respectively; and
drive switching elements included in the two bridge circuits at the switching frequency.

7. A method for controlling a power converter, the method comprising:
setting a switching frequency higher than a maximum value of a resonant frequency of a closed-loop circuit of the power converter, the closed-loop circuit including arbitrary two of bridge circuits and an inductance element, the inductance element connected between an AC terminal of one of the arbitrary two of the bridge circuits and an AC terminal of another one of the two bridge circuits, the closed-loop circuit further including a capacitor connected between the inductance element and at least one of respective AC terminals of the two bridge circuits, the bridge circuits connected to more than three external connection terminals, respectively; and
driving switching elements included in the two bridge circuits at the switching frequency.
